(19) United States
(12) Patent Application Publication
(10) Pub. No.: US 2024/0101099 A1
(43) Pub. Date: Mar. 28, 2024

(54) METHOD OF CONTROLLING OPERATION OF AN ARTICULATED VEHICLE COMBINATION

(71) Applicant: Volvo Truck Corporation, Göteborg (SE)

(72) Inventors: Leo Laine, Härryda (SE); Mats Jonasson, Partille (SE)

(21) Appl. No.: 18/039,518

(22) PCT Filed: Dec. 7, 2020
(86) PCT No.: PCT/EP2020/084828

§ 371 Date: May 31, 2023

(51) Int. Cl. B60W 20/10; B60W 30/02

(52) U.S. Cl. CPC B60W 20/10; B60W 30/02; B60W 2520/22; B60W 2720/40

(57) ABSTRACT

The present disclosure relates to a method of controlling operation of an articulated vehicle combination (AVC), the AVC comprising a tractor unit comprising a primary prime mover for propulsion of the AVC, a first trailer unit coupled to the tractor unit by a first articulated coupling, a dolly comprising a secondary prime mover, the dolly being coupled to the first trailer unit by a second articulated coupling, and a second trailer unit coupled to the dolly by a third articulated coupling, the method comprising determining at least one property indicative of a stability of the AVC; comparing the property with a predetermined property specific range; and controlling the secondary prime mover to generate a propulsion torque for the AVC when the property is within the predetermined property specific range.

### TECHNICAL FIELD

The present disclosure relates to a method of controlling an articulated vehicle combination (AVC). The present disclosure also relates to an AVC control system as well as an AVC comprising such a control system. The present disclosure is applicable to vehicle combinations comprising at least a towing vehicle and a towed vehicle connected to each other by an articulated coupling. Although the disclosure will mainly be directed to a vehicle combination in the form of a truck-trailer, it may also be applicable for other types of vehicles such using vehicle units connected by articulated couplings, such as e.g. working machines.

### BACKGROUND

In order to increase the operational capacity of heavy-duty vehicles, vehicle combinations with a plurality of units are increasingly popular. Hereby, the vehicle is able to transport a substantive amount of material when driving from one position to another. These vehicle units are also referred to as articulated vehicle combinations, or multi-trailers. Each unit of the multi-trailer is connected to another unit by means of an articulated coupling allowing a mutual rotation between the units.

The multi-trailers also often comprise a dolly arranged between two trailers of the articulated vehicle. As these multi-trailer that use such an intermediate dolly are larger—longer and heavier—in comparison to a conventional heavy duty vehicle, they tend to consume a lot of power and energy during propulsion.

There is thus a desire to be able to reduce the overall energy consumption for these types of vehicles, in particularly to reduce harmful exhaust gases.

### SUMMARY

It is thus an object of the present disclosure to at least partially overcome the above described deficiencies. This object is achieved by a method according to claim 1.

According to a first aspect, there is provided a method of controlling operation of an articulated vehicle combination, AVC, the AVC comprising a tractor unit comprising a primary prime mover for propulsion of the AVC, a first trailer unit coupled to the tractor unit by a first articulated coupling, a dolly comprising a secondary prime mover, the dolly being coupled to the first trailer unit by a second articulated coupling, and a second trailer unit coupled to the dolly by a third articulated coupling, the method comprising determining at least one property indicative of a stability of the AVC; comparing the property with a predetermined property specific range; and controlling the secondary prime mover to generate a propulsion torque for the AVC when the property is within the predetermined property specific range.

The wording primary prime mover should be construed as a prime mover, preferably an internal combustion engine or an electric motor, arranged to propel the wheels of the tractor unit, while the secondary prime mover is arranged to propel the wheels of the dolly. The secondary prime mover is, as will also be described below, preferably one or more electric motors. The dolly should thus be construed as an intermediate trailer arranged between the first and second trailers. The dolly can thus be used as the propulsion unit for the vehicle when operating the vehicle using the secondary prime mover.

Moreover, and as will be described further below, the property indicative of the stability of the AVC should be construed as e.g. force parameters, torque parameters, articulated angle parameters, slip parameters, etc.

The present disclosure is based on the insight that a secondary prime mover can be arranged on the dolly to generate a sufficient propulsion for the AVC during a plurality of driving situations. Hereby, the dolly can comprise a secondary prime mover in the form of one or more electric motors. An overall advantage is thus that an at least partial re-allocation of propulsion from the primary prime mover to the secondary prime mover will reduce the emission of environmentally harmful exhaust gas when using an internal combustion engine as primary prime mover. However, transitioning from the primary prime mover to the secondary prime mover can result in stability complications for the AVC as the secondary prime mover of the dolly is arranged at a tailing position relative to the primary prime mover. A further advantage of the present disclosure is thus that the at least one property indicative of the stability should be within a predetermined property specific range. Hence, the secondary prime mover is controlled to generate a propulsion torque only when the AVC is sufficiently stable. Accordingly, and according to an example embodiment, the secondary may be controlled to generate the propulsion torque for the AVC only when the property is within the predetermined property specific range The property specific range should be construed as a range which is specific for the evaluated property. Thus, the range may be different for a force parameter compared to a torque parameter, etc.

Also, by determining the at least one property indicative of the stability of the AVC, and comparing the property with the predetermined range, initiation of propulsion using the secondary prime mover can be selected and controlled in a suitable manner. Hereby, so-called jack-knifing and swing-out can be avoided. Jack-knifing should be construed as, for example, a situation where the truck is braking too much, and the trailer is pushing on the articulated coupling. Hereby, there is a risk that the first and second vehicle will be exposed to a jack-knife at the articulated coupling, i.e. the articulated angle between the first and first trailer units will be too severe. Jack-knifing can otherwise occur at, for example, situations when driving downhill at low friction between the surface of the tires on the axle behind the articulated coupling, i.e. the axle(s) on the first trailer unit, and the road surface. This axle positioned behind the articulated coupling is thus in many cases arranged to provide an engine braking operation and/or a regenerative braking operation for the vehicle. During e.g. braking, the wheels/tires might lose the lateral grip force to the ground surface which makes the tractor unit prone for jack-knifing when the first trailer unit, i.e. the trailer is pushing. Low friction and poor normal force distribution on the vehicle combination can lead to a jack-knife situation. For example, in a tractor-trailer combination, the rear part of the trailer can be heavily laden, while the front part of the trailer is less laden. This can lead to low vertical load transfer in a fifth wheel above the driven wheels. If braking is conducted using the driveline, the vehicle combination becomes vulnerable to jack-knifing due to the low normal force. Accordingly, the articulated coupling is exposed to a compression force and the lateral wheel forces cannot counteract this increased compression force. Swing-out should on the other hand be construed such that the tires of the first trailer unit, i.e. the tires of the trailer, loses lateral grip on the road, whereby the trailer risk swinging laterally relative to the tractor unit, i.e. the truck. The swing-out situation could occur during increased braking of the rear vehicle unit, i.e. the trailer, whereby the wheels of the trailer loses their grip to the road surface.

According to an example embodiment, the method may further comprise reducing an operational capacity of the primary prime mover when controlling propulsion using the secondary prime mover.

Reducing the operational capacity should be construed as reducing the torque generated by the primary prime mover. Preferably, the operational capacity is reduced to zero, i.e. the primary prime mover is shut off, or a transmission arrangement connected to the primary prime mover is put in a neutral gear stage such that the primary prime mover is free-wheeling and not producing a torque to the wheels of the tractor unit. Hereby, the fuel and energy consumption of the AVC will be reduced.

According to an example embodiment, the at least one property may comprise a coupling force parameter of at least one of the first, second or third articulated couplings, wherein the secondary prime mover is controlled to generate the propulsion torque when the coupling force parameter is within a predetermined force parameter range.

The articulated coupling force parameters represent a good indication of the stability of the AVC. Thus, if at least one of the articulated coupling force parameters is within the predetermined force parameter range, a transition from the primary prime mover to the secondary prime mover can be executed.

According to an example embodiment, the coupling force parameter may comprise a lateral force component exposing the at least one of the first, second or third articulated couplings to a lateral force during operation of the AVC.

The lateral force component may be seen as lateral relative to either one of the tractor unit, the first trailer unit, the dolly or the second trailer unit. In further detail, the lateral force component can be a force component which is acting laterally to the first articulated coupling as seen from the tractor unit, or a force component acting laterally on the third articulated coupling as seen from the third trailer unit.

According to an example embodiment, the coupling force parameter may comprise a torque component exposing at least one of the first, second or third articulated couplings to a torque around a longitudinally extending geometric axis during operation of the AVC.

By determining a torque acting on one of the articulated couplings, the risk of accidentally arriving at a roll-over situation when transitioning from the primary prime mover to the secondary prime mover is reduced. The longitudinal extension could be seen as relative to any one of the tractor unit, the first trailer unit, the dolly or the second trailer unit depending on which of the articulated couplings being exposed to the torque, in a similar vein as described for the lateral force component.

According to an example embodiment, the at least one property may comprise an articulated angle of at least one of first, second or third articulated couplings during operation of the AVC, wherein the secondary prime mover is controlled to generate the propulsion torque when the articulated angle is within a predetermined angle range.

Hereby, the risk of transitioning from the primary prime mover to the secondary prime mover when e.g. driving at a curvature is reduced, as curvatures may represent particularly disadvantageous driving situations for executing such propulsion torque transitioning.

According to an example embodiment, the at least one property may comprise a lateral slip parameter indicative of a lateral slip value of at least one wheel of the AVC, wherein the secondary prime mover is controlled to generate the propulsion torque when the lateral slip value is within a predetermined slip range.

The lateral slip should slip should be construed as the relative motion between a tire and the road surface it is moving on. The lateral slip can be generated either by the tire's rotational speed being greater or less than the free-rolling speed, which is usually described as percent slip, or by the tire's plane of rotation being at an angle to its direction of motion, also referred to as slip angle. Lateral slip presents a good indication whether the AVC is operated in a stable manner or not. Transitioning the propulsion from the primary prime mover to the secondary prime mover is thus advantageously executed when the lateral slip is relatively low.

According to an example embodiment, the method may further comprise determining a first longitudinal force parameter value of the AVC during propulsion solely using the primary prime mover; and controlling the primary and secondary prime movers to contemporaneously generate a propulsion torque exposing the AVC to a second longitudinal force parameter value during a transition period when initiating propulsion using the secondary prime mover, the second longitudinal force parameter value being within a predetermined range from the first longitudinal force parameter value.

Hereby, the sum of the longitudinal forces is substantially constant when transitioning from the primary prime mover to the secondary prime mover. Thus, the transitioning will be executed in a relatively smooth manner and an operator of the vehicle may not feel any substantial disruptions in operation. The predetermined range should preferably be set as close to zero as possible. It should however be understood that the coupling forces in the articulated coupling(s) need not necessarily be zero, or close to zero. For example, the first articulated coupling is exposed to a pulling longitudinal coupling force as the first articulated coupling is “pulled” from the tractor unit. As the propulsion is transitioned to the secondary prime mover, the first articulated coupling is “pushed” by the secondary prime mover of the dolly, which is positioned behind the first articulated coupling as seen in the longitudinal forward direction of the AVC. Hence, the longitudinal coupling force can change sign during the transition.

According to an example embodiment, the method may further comprise determining a first lateral force parameter value of the AVC during propulsion solely using the primary prime mover; and controlling the primary and secondary prime movers to contemporaneously generate a propulsion torque exposing the AVC to a second lateral force parameter value during a transition period when initiating propulsion using the secondary prime mover, the second lateral force parameter value being within a predetermined range from the first lateral force parameter value.

According to an example embodiment, the method may further comprise determining a first angle value of at least one of the first, second and third articulated couplings during propulsion solely using the primary prime mover; and controlling the primary and secondary prime movers to contemporaneously generate a propulsion torque exposing the AVC to a second angle value during a transition period when initiating propulsion using the secondary prime mover, the second angle value being within a predetermined range from the first angle value.

According to an example embodiment, the primary prime mover may be an internal combustion engine of the tractor unit.

According to an example embodiment, the secondary prime mover may be at least one electric machine of the dolly. The electric machine may, for example, be an electric hub motor.

According to a second aspect, there is provided an articulated vehicle combination, AVC, control system configured to control operation of an AVC comprising a tractor unit comprising a primary prime mover for propulsion of the AVC, a first trailer unit coupled to the tractor unit by a first articulated coupling, a dolly comprising a secondary prime mover, the dolly being coupled to the first trailer unit by a second articulated coupling, a second trailer unit coupled to the dolly by a third articulated coupling, and at least one sensor arranged to sense at least one property indicative of a stability of the AVC, wherein the AVC control system comprises control circuitry configured to receive a signal indicative of the property form the at least one sensor; compare the property with a predetermined property specific range; and transmit a propulsion signal to the secondary prime mover, the propulsion signal allowing the secondary prime mover to generate a propulsion torque for the AVC when the property is within the predetermined property specific range.

According to an example embodiment, the AVC control system may comprise a tractor unit control system and a dolly control system, wherein the tractor unit control system is configured to control operation of the primary prime mover, and the dolly control system is configured to control operation of the secondary prime mover.

Hereby, the tractor unit and the dolly each comprises a sub-system for controlling operation of the primary prime mover and the secondary prime mover, respectively.

According to an example embodiment, the control circuitry may be configured to transmit the propulsion signal to the dolly control system, the propulsion signal representing instructions which, when executed by the dolly control system, cause the secondary prime mover to generate the propulsion torque.

According to an example embodiment, the control circuitry may be configured to transmit a propulsion reduction signal to the tractor unit control system, the propulsion reduction signal representing instructions which, when executed by the tractor unit control system, cause the primary prime mover to reduce its operational capacity. Hereby, the primary prime mover is preferably shut off to reduce the power consumption of the AVC.

Thus, the control circuitry may be configured to contemporaneously, i.e. at substantially the same time, transmit the propulsion signal to the dolly control system and the propulsion reduction signal to the tractor unit control system.

Further effects and features of the second aspect are largely analogous to those described above in relation to the first aspect.

According to a third aspect, there is provided an articulated vehicle combination, AVC, comprising a tractor unit comprising a primary prime mover for propulsion of the AVC, a first trailer unit coupled to the tractor unit by a first articulated coupling, a dolly comprising a secondary prime mover, the dolly being coupled to the first trailer unit by a second articulated coupling, a second trailer unit coupled to the dolly by a third articulated coupling, and an AVC control system according to any one of the embodiments described above in relation to the second aspect.

Effects and features of the third aspect are largely analogous to those described above in relation to the first and second aspects.

According to a fourth aspect, there is provided a computer program comprising program code means for performing the steps of any one of the embodiments described above in relation to the first aspect when the program is run on a computer.

According to a fifth aspect, there is provided a computer readable medium carrying a computer program comprising program means for performing the steps of any one of the embodiments described above in relation to the first aspect when the program means is run on a computer.

Effects and features of the fourth and fifth aspects are largely analogous to those described above in relation to the first and second aspects.

Further features of, and advantages will become apparent when studying the appended claims and the following description. The skilled person will realize that different features may be combined to create embodiments other than those described in the following, without departing from the scope of the present disclosure.

### BRIEF DESCRIPTION OF THE DRAWINGS

The above, as well as additional objects, features and advantages, will be better understood through the following illustrative and non-limiting detailed description of exemplary embodiments, wherein:

FIG. 1 is a lateral side view illustrating an example embodiment of an articulated vehicle combination, where the articulated vehicle combination comprises a tractor unit, a first trailer unit, a dolly and a second trailer unit;

FIG. 2 is a top view of the tractor unit and the first trailer unit of FIG. 1;

FIG. 3 is a side view of the tractor unit and the first trailer unit of FIG. 1;

FIG. 4 is a rear view of the tractor unit in the articulated vehicle combination in FIG. 1;

FIG. 5 is a rear view of the first trailer unit in the articulated vehicle combination in FIG. 1;

FIG. 6 is a top view of the first trailer unit, the dolly and the second trailer unit of the articulated vehicle combination in FIG. 1;

FIG. 7 is a control system for controlling the articulated vehicle combination in FIG. 1 according to an example embodiment;

FIG. 8 is a further detailed illustration of the control system in FIG. 7; and

FIG. 9 is a flow chart of a method for controlling the articulated vehicle combination in FIG. 1 according to an example embodiment.

### DETAILED DESCRIPTION

The present disclosure will now be described more fully hereinafter with reference to the accompanying drawings, in which exemplary embodiments are shown. The disclosure may, however, be embodied in many different forms and should not be construed as limited to the embodiments set forth herein; rather, these embodiments are provided for thoroughness and completeness. Like reference character refer to like elements throughout the description.

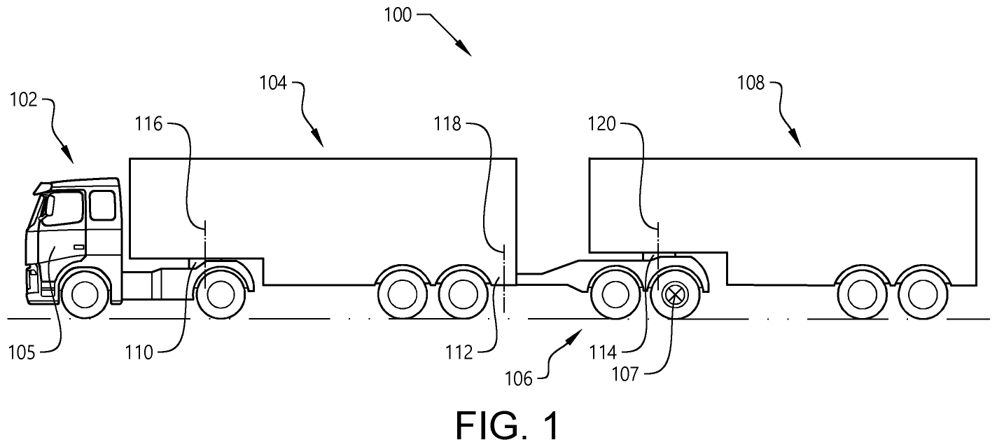

With particular reference to FIG. 1, there is depicted an articulated vehicle combination (AVC) 100 in the form of a multi-trailer truck 100. The AVC 100 comprises a tractor unit 102, a first trailer unit 104, a dolly 106 and a second trailer unit 108. Although the AVC 100 depicted in FIG. 1 comprises four vehicle units, the present disclosure is equally applicable for a vehicle combination comprising arbitrary many vehicle units, such as e.g. also a fifth, a sixth, a seventh trailer unit, etc.

Moreover, the AVC comprises a primary prime mover 105 arranged on the tractor unit 102. The primary prime mover 105 is preferably an internal combustion engine, or an electric motor. Further, the dolly 106 comprises a secondary prime mover 107, such as preferably an electric motor or electric machine. Hereby, the AVC can be propelled by either the primary prime mover 105 or by the secondary prime mover 107, or by a combination of the primary prime mover 105 and the secondary prime mover 107.

Moreover, the tractor unit 102 is connected to the first trailer unit 104 by a first articulate coupling 110, the first trailer unit 104 is connected to the dolly 106 by a second articulate coupling 112, and the dolly 106 is connected to the second trailer unit 108 by a third articulate coupling 114. Hereby, the vehicle units are allowed to rotate relative to each other around a respective first 116, second 118 and third 120 substantially vertical geometric axis.

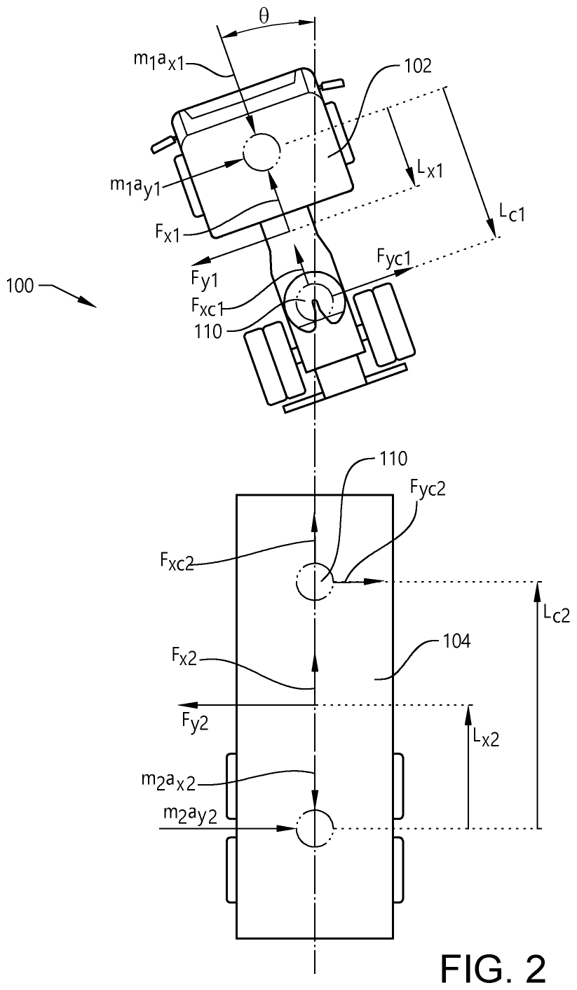

During operation, the articulated couplings 110, 112, 114 of the AVC 100 are exposed to coupling forces, such as e.g. longitudinal and lateral forces, as well as torque loads. Hence, the AVC 100 is exposed to a property indicative of the stability. This property will in the following also be referred to as a motion related parameters, such as the forces, articulated angles, torques, slip, etc. exposed to the AVC 100. Also, the articulated couplings 110, 112, 114 are exposed to torque loads around a longitudinally extending geometric axis of the AVC 100. These coupling forces are generated during operation of the AVC 100. In order to describe these coupling force parameters in further detail, reference is made to FIGS. 2-6 which illustrate an example embodiment of an AVC 100 comprising the tractor unit 102, the first trailer unit 104, the dolly 106 and the second trailer unit 108. Thus, the following disclosure will, for simplicity of understanding, not include all vehicle units in each of the following figures. However, it should be readily understood that the coupling force parameters of the non-illustrated articulated couplings are determined in a similar manner as for the articulated couplings described below.

Starting with FIG. 2, which is a top view of the tractor unit 102 and the first trailer unit 104. The AVC 100 is in FIG. 2 arranged in a somewhat exploded view so that the tractor unit 102 is separated from the first trailer unit 104. Thus, FIG. 2 is exploded in this manner to simplify the illustration of the coupling force parameters of the first articulated coupling 110 as well as the motion related parameters obtained from the first 102 and second 104 vehicle units.

As can be seen in FIG. 2, the tractor unit 102 turns to the left by an articulated angle θ. Thus, the tractor unit 102 and the first trailer unit 104 are rotated relative to each other around the articulated coupling 110 by the articulated angle θ. The articulated angle θ can be measured by e.g. an angle sensor, an input signal from the steering wheel, and/or from an Advanced driver-assistance system (ADAS). Further, during propulsion, the vehicle is exposed to a longitudinal acceleration component, aₓ₁, and a lateral acceleration a_{y1}. The lateral acceleration ay, is generated as the tractor unit 102 is turning. The longitudinal and lateral acceleration components can be determined by means of inertial measurement units (IMUs) or similar sensors.

The first trailer unit 104 is exposed to a longitudinal acceleration component, αₓ₂, as can also be obtained by an IMU. As the first trailer unit 104 in FIG. 2 is still operated straight forward, it is not exposed to a lateral acceleration component at this stage.

Furthermore, when the vehicle combination is operated, actuation forces, Fₓ₁, and Fₓ₂, of the tractor unit 102 and the first trailer unit 104 can be obtained from actuators of the vehicle, such as e.g. electric machines configured to generate an operating torque on the propelled wheels of the respective tractor unit 102 and the first trailer unit 104. Based on the above described motion related parameters, the following equations (1)-(6) can be generated to determine the coupling force parameters of the articulated coupling.

m₁αₓ₁=Fₓ₁+F_{xc1} (1)

m₂αₓ₂=Fₓ₂+F_{xc2} (2)

m₁α_{y1}=F_{y1}−F_{y1}−F_{yc1} (3)

m₂α_{y2}=F_{y2}−F_{yc2} (4)

J_{z1}\dot{ω}_{z1}=−F_{y1}Lₓ₁+F_{yc1}L_{c1} (5)

J_{z2}\dot{ω}_{z2}=F_{y2}Lₓ₂−F_{yc2}L_{c2} (6)

### Where:

m₁ is the mass of the tractor unit 102;
m₂ is the mass of the first trailer unit 104;
\dot{ω}_{z1} is the angular acceleration of the tractor unit 102;
\dot{ω}_{z2} is the angular acceleration of the first trailer unit 104;
F_{y1} is the lateral forces generated on the tractor unit 102;
F_{y2} is the lateral forces generated on the first trailer unit 104;
J_{z1} is the moment of inertia of the tractor unit 102;
J_{z2} is the moment of inertia of the first trailer unit 104;
Lₓ₁ is the longitudinal length from the center of mass of the tractor unit 102 to a position at which the lumped tractive force Fₓ₁ is exposed to the tractor unit 102;
L_{c1} is the longitudinal length from the center of mass of the tractor unit 102 to the position of the articulated coupling 110;
Lₓ₂ is the longitudinal length from the center of mass of the first trailer unit 104 to a position at which the lumped tractive force Fₓ₂ is exposed to the first trailer unit 104;
L_{c2} is the longitudinal length from the center of mass of the first trailer unit 104 to the position of the articulated coupling 110;
F_{xc1} is the longitudinal coupling force component as seen in a local coordinate system of the tractor unit 102;
F_{yc1} is the lateral coupling force component as seen in a local coordinate system of the tractor unit 102;
F_{xc2} is the longitudinal coupling force component as seen in a local coordinate system of the first trailer unit 104; and
F_{yc2} is the lateral coupling force component as seen in a local coordinate system of the first trailer unit 104.

The angular accelerations \dot{ω}_{z1} and \dot{ω}_{z2} can, in a similar manner as the longitudinal and lateral acceleration components be determined by obtaining a signal from an IMU or similar sensor. The mass of the first 102 and second 104 vehicle units, as well as the moments of inertia J_{z1} and J_{z2} are also known beforehand.

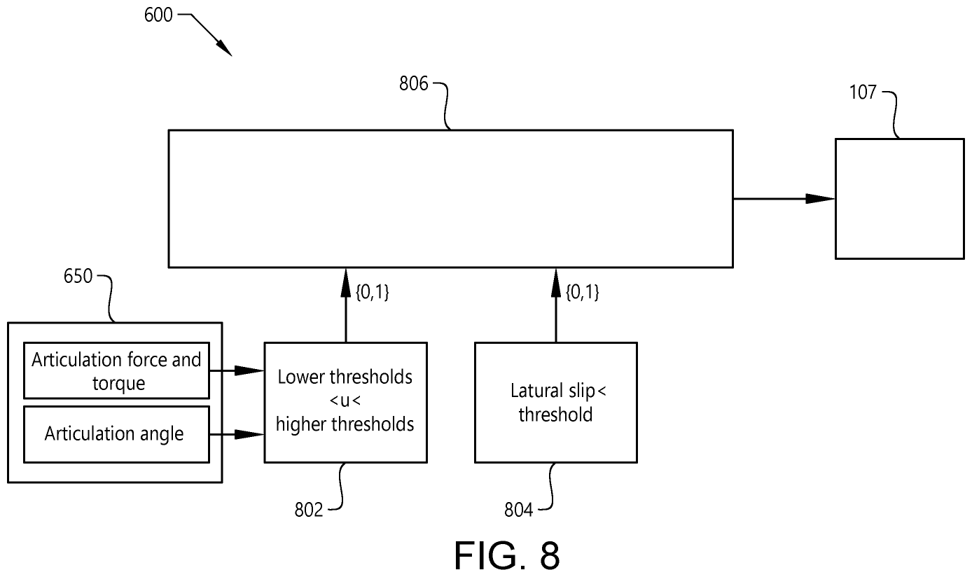

Thus, the above equations (1)-(6) contains the known parameters m₁, m₂, αₓ₁, αₓ₂, α_{y1}, α_{y2}, \dot{ω}_{z1}, \dot{ω}_{z2}, J_{z1} and J_{z2} and the unknown parameters F_{xc1}, F_{yc1}, F_{xc2}, F_{yc2}, F_{y1}, F_{y2} Lₓ₁ Lₓ₂. Thus, six equations and six unknown parameters, which presents an equation system which is solvable. In particular, the coupling force parameters F_{xc1}, F_{yc1}, F_{xc2} and F_{yz2} can be determined, which can be used for the application as described further below in relation to FIG. 8.

The above described longitudinal forces Fₓ₁ and Fₓ₂ are thus the sum of wheel torques, i.e. actuated torque from brake and/or propulsion units, among the wheels of the respective vehicle unit divided by the wheel radius.

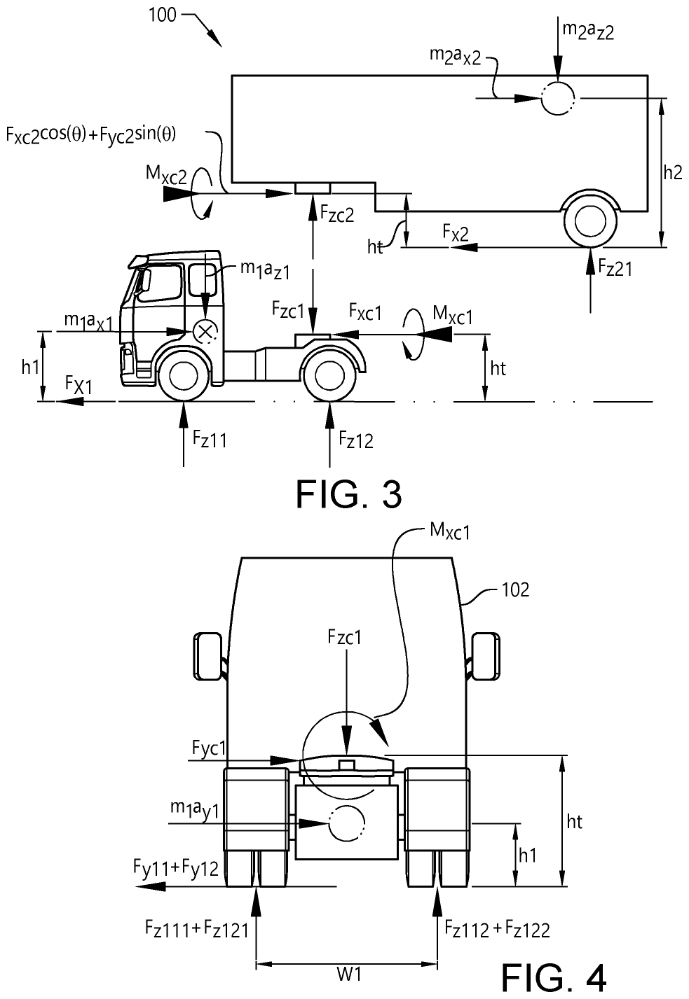

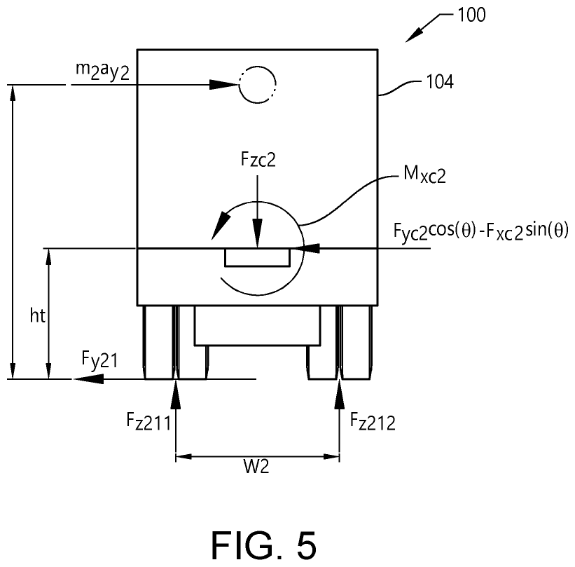

Turning now to FIGS. 3-5, which are a side view and rear views of the AVC 100 according to an example embodiment. In particular, FIG. 4 is a rear view of the tractor unit 102 and FIG. 5 is a rear view of the first trailer unit 104. Motion related parameters already described in relation to FIG. 2 will not be described in further detail below but should be construed as also being present for the illustrations of FIGS. 3-5.

From the illustrations of FIGS. 3-5, the following equations (7)-(19) can be generated.

$${M}_{x c 2} + {F}_{z 212} \times \frac{{W}_{2}}{2} - {F}_{z 211} \times \frac{{W}_{2}}{2} - {m}_{2} {a}_{y 2} ( {h}_{2} - {h}_{t} ) = 0 \qquad ( 7 )$$

$${M}_{x c 1} + ( {F}_{z 111} + {F}_{z 121} ) \times \frac{{W}_{1}}{2} - ( {F}_{z 112} + {F}_{z 122} ) \times \frac{{W}_{1}}{2} - {m}_{1} {a}_{y 1} ( {h}_{t} - {h}_{1} ) = 0 \qquad ( 8 )$$

$${F}_{z c 2} + {F}_{z 21} - {m}_{2} {a}_{z 2} = 0 \qquad ( 9 )$$

$$- {F}_{z c 1} + {F}_{z 11} + {F}_{z 12} - {m}_{1} {a}_{z 1} = 0 \qquad ( 10 )$$

$${F}_{z 11} = {F}_{z 111} + {F}_{z 112} \qquad ( 11 )$$

$${F}_{z 12} = {F}_{z 121} + {F}_{z 122} \qquad ( 12 )$$

$${F}_{z 21} = {F}_{z 211} + {F}_{z 212} \qquad ( 13 )$$

$${F}_{x c 2} cos ( θ ) + {F}_{yc 2} sin ( θ ) + {m}_{2} {a}_{x 2} - {F}_{x 2} = 0 \qquad ( 14 )$$

$${F}_{x c 1} + {F}_{x 1} - {m}_{1} {a}_{x 1} = 0 \qquad ( 15 )$$

$${F}_{yc 1} = {F}_{y 11} + {F}_{y 12} - {m}_{1} {a}_{y 1} \qquad ( 16 )$$

$${F}_{yc 2} cos ( θ ) - {F}_{x c 2} sin ( θ ) - {m}_{2} {a}_{y 2} + {F}_{y 21} = 0 \qquad ( 17 )$$

$${F}_{x 1} \times {h}_{t} - {m}_{1} {a}_{x 1} \times ( {h}_{t} - {h}_{1} ) = 0 \qquad ( 18 )$$

$${m}_{2} {a}_{x 2} \times ( {h}_{2} - {h}_{t} ) - {F}_{x 2} \times {h}_{t} = 0 \qquad ( 19 )$$

where:
M_{xc1} is the coupling torque component as seen in a local coordinate system of the tractor unit 102;
M_{xc2} is the coupling torque component as seen in a local coordinate system of the first trailer unit 104;
h₁ is the height from ground to the center of mass of the tractor unit; and
h₂ is the height from ground to the center of mass of the first trailer unit

As described above in relation to the description of FIG. 2, the acceleration parameters can be determined by e.g. IMUs and the tractive forces can be obtained from the actuators. Hereby, the vertical coupling force F_{yc} and the coupling torque M_{xc} of the articulated coupling can be determined.

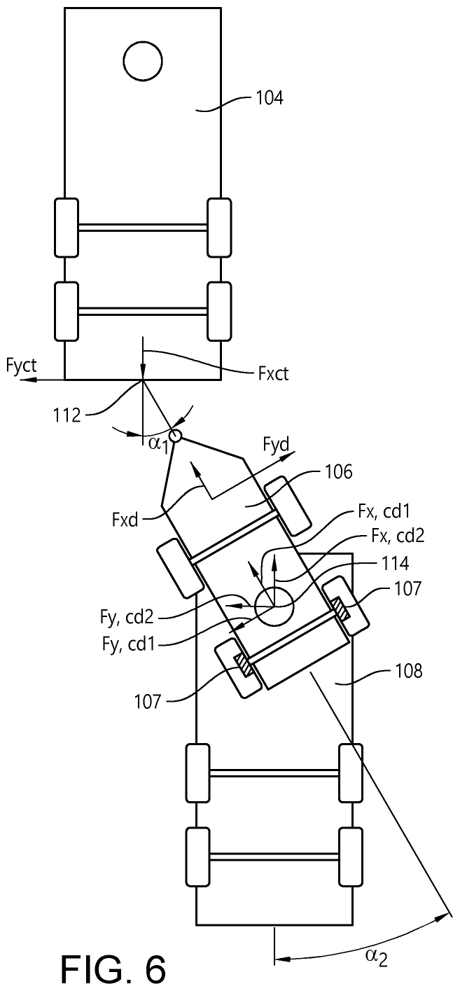

Turning to FIG. 6, which illustrates the first trailer unit 104, the dolly 106 and the second trailer unit 108. The first trailer unit 104 and the dolly 106 are rotated relative to each other by an articulated angle α₁ at the second articulated coupling 112, while the dolly 106 and the second trailer unit 108 are rotated relative to each other by an articulated angle α₂ at the third articulated coupling 114.

As can be seen by the illustration in FIG. 6, the second articulated coupling 112 is exposed to a lateral force component F_{yct} and a longitudinal force component F_{xct} as seen in a local coordinate system of the second trailer unit 104. Furthermore, the third articulated coupling 114 is exposed to lateral force component F_{y,cd1} and a longitudinal force component F_{x,cd1} as seen in a local coordinate system of the dolly 106, as well as exposed to lateral force component F_{y,cd2} and a longitudinal force component F_{x,cd2} as seen in a local coordinate system of the second trailer. The dolly is also exposed to a longitudinal force component F_{xd} and a lateral force component F_{yd} as seen in the local coordinate system of the dolly 106. By means of the force components depicted in FIG. 6, the following equations (20)-(21) can be generated for the third articulated coupling 114:

F_{x,cd1} cos(α₁)+F_{x,cd2}−F_{y,cd1} sin(α₁)=0 (20)

F_{y,cd2}+F_{y,cd1} cos(α₁)+F_{x,cd1} sin(α₁)=0 (21)

When the articulated angle α₁ equals 90 degrees, F_{x,cd2}=F_{y,cd1} and F_{y,cd2}=−F_{x,cd1}.
When the articulated angle α₁ equals 0 degrees, F_{x,cd1}=F_{x,cd2} and F_{y,cd2}=−F_{y,cd1.}

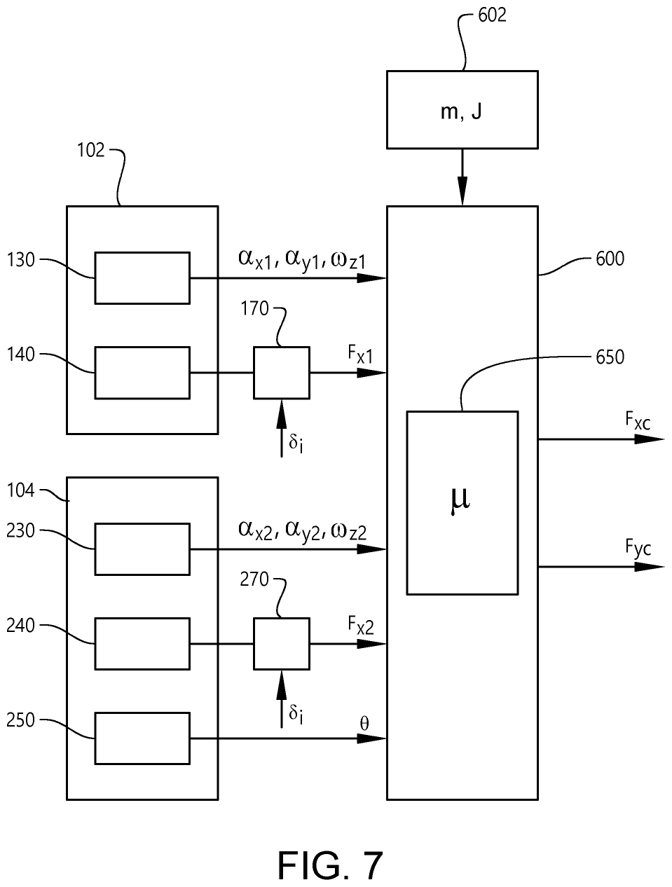

Turning to FIG. 7 which illustrates an AVC control system 600 according to the present disclosure. The AVC control system 600 depicted in FIG. 7 is arranged to determine the above described longitudinal coupling force F_{xc} and lateral coupling force F_{yz}. It should however be readily understood that the AVC control system 600 is equally applicable for determining the vertical coupling force F_{xc} and the coupling torque M_{xc} by implementing also the equations (7)-(21) described above, i.e. for all vehicle units forming part of the AVC.

The AVC control system 600 comprises control circuitry 650 which may each include a microprocessor, microcontroller, programmable digital signal processor or another programmable device. The AVC control circuitry 650 may also, or instead, each include an application specific integrated circuit, a programmable gate array or programmable array logic, a programmable logic device, or a digital signal processor. Where the control circuitry 650 includes a programmable device such as the microprocessor, microcontroller or programmable digital signal processor mentioned above, the processor may further include computer executable code that controls operation of the programmable device. It should be understood that all or some parts of the functionality provided by means of the control circuitry 650 may be at least partly integrated with the below described IMUs 130, 230, actuators 140, 240, angle sensor 250 and mass and inertia estimator 602.

As can be seen, the AVC control system 600 receives a longitudinal acceleration component αₓ₁, a lateral acceleration component α_{y1} and a rotational velocity component α_{z1} from an IMU 130 of the tractor unit 102. The AVC control system 600 also receives longitudinal wheel forces Fₓ, from the tractor unit 102, which are defined as a sum, calculated by a first force summation module 170, of longitudinal wheel forces received from actuators 140 of the tractor unit 102.

Moreover, the control system receives a longitudinal acceleration component αₓ₂, a lateral acceleration component α_{y2} and a rotational velocity component α_{z2} from an IMU 230 of the first trailer unit 104. The AVC control system 600 also receives longitudinal wheel forces Fₓ₂ from the first trailer unit 104, which are defined as a sum, calculated by a second force summation module 270, of longitudinal wheel forces received from actuators 240 of the first trailer unit 104. Also, the control system receives an articulated angle θ of the articulated coupling 110, i.e. the relative angular displacement between the first 102 and second 104 vehicle units. Although FIG. 7 illustrates that the articulated angle is received from an angle sensor 250 of the first trailer unit 104, this angle sensor 250 can equally form part of the tractor unit 102.

Moreover, the AVC control system 600 receives parameter values indicative of vehicle mass m and moment of inertia J from a mass and inertia estimator 602. Thus, the mass and inertia estimator 602 is arranged to transmit parameter values indicative of the mass m₁ of the tractor unit 102, the mass m₂ of the first trailer unit 104, the moment of inertia J₁ of the tractor unit 102 and the moment of inertia J₂ of the first trailer unit 104.

When receiving the motion related parameters of the first 102 and second 104 vehicle units, the control system determines, based on the above described equations, the coupling force parameters, here indicated as the longitudinal F_{xc} and lateral F_{yz} coupling force parameters, of the articulated coupling. Although not depicted in FIG. 7, the control circuit 650 can also transmit torque components and articulated angles of the various articulated couplings of the AVC 100 as will be evident with the below disclosure of FIG. 8, which is a further detailed illustrations of the AVC control system. The AVC control system 600 comprises a dolly control system 806 arranged to control operation of the secondary prime mover 107.

Articulated forces and torques as described above are transmitted to a comparison module 802. Hereby, the forces and torques are compared to a threshold value, i.e. a predetermined property range. If the forces and torques fulfil the requirements, i.e. are within the predetermined property range, a signal is transmitted to the dolly control system 806 indicating digit {1}, i.e. the requirements are fulfilled. If not fulfilled, i.e. outside the predetermined property range, the signal is indicating digit {0}. Also, current articulated angles of the different articulated couplings are transmitted to the comparison module 802. If the articulated angle(s) are within a predetermined angle range, the comparison module 802 transmit a signal indicating digit {1}, i.e. the angle requirements are fulfilled. If the angle requirements are not fulfilled, i.e. outside the predetermined property range, the signal is indicating digit {0}.

The dolly control system 806 receives the signals from the comparison module 802. If the combination of the signals indicate digit {1}, i.e. the forces, torques and articulated angles are within their predetermined property range, the dolly control system 806 transmits a control signal to the secondary prime mover 107 to generate a propulsion torque for the AVC. At the same time, the dolly control system 806 can control the primary prime mover to reduce its operational capacity, preferably controlling the primary prime mover to be shut off.

On the other hand, if the combination of the signals indicate digit {0}, i.e. at least one of the forces, torques and articulated angles are not within their predetermined property range, the dolly control system 806 awaits the control of the secondary prime mover.

In addition to the signals received from the comparison module 802, the dolly control system 806 can also receive a signal from a lateral slip module 804. In particular, the lateral slip module 804 receives lateral slip parameter indicative of a lateral slip value of at least one wheel of the AVC 100. The lateral slip module 804 compares the lateral slip parameter with a predetermined slip range. If the lateral slip parameter is within the predetermined slip range, the lateral slip module 804 transmits a digit {1} to the dolly control system 806. If the lateral slip parameter is not within the predetermined slip range, the lateral slip module 804 transmits a digit {0} to the dolly control system 806. The dolly control system 806 controls the secondary prime mover to generate a propulsion torque if also the lateral slip fulfils the predetermined requirements.

In order to operate the AVC 100 in a convenient manner and not exposing e.g. an operator to an uncomfortable operation when transitioning form the propulsion using the primary prime mover to propulsion using the secondary prime mover, the AVC control system 600 also determines a first longitudinal force parameter value of the AVC during propulsion solely using the primary prime mover. The control circuit transmits a control signal to the dolly control system 806 to control the primary and secondary prime movers to contemporaneously generate a propulsion torque exposing the AVC to a second longitudinal force parameter value during a transition period when initiating propulsion using the secondary prime mover, the second longitudinal force parameter value being within a predetermined range from the first longitudinal force parameter value. Preferably, the first and second longitudinal force parameter value are substantially the same for optimized comfort.

In a similar manner, the control circuit may transmit control signal to the dolly control system 806 to control the primary and secondary prime movers to contemporaneously generate a propulsion torque exposing the AVC to substantially the same lateral forces and angles of the articulated coupling during the transition period when initiating propulsion using the secondary prime mover.

Although the description in relation to FIGS. 7 and 8 are directed to solely one AVC control system, the AVC control system may comprise comprises a tractor unit control system in addition to the above described dolly control system, wherein the tractor unit control system is configured to control operation of the primary prime mover, and the dolly control system is configured to control operation of the secondary prime mover.

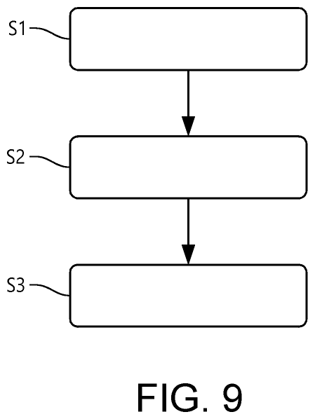

In order to sum up, reference is made to FIG. 9 which is a flow chart of a method for controlling operation of the AVC 100 depicted in FIG. 1. During operation, at least one property indicative of the stability of the AVC is determined S1. As described above, the property indicative of the stability of the AVC may relate to e.g. coupling force parameters of the articulated couplings, articulated angles, torque components, etc. exposed to the AVC 100 during operation. The property is compared S2 to a predetermined property range, i.e. a property in the form of a lateral force is compared to a force threshold, while a property in the form of an articulated angle is compared to an angle threshold. When the property is within the predetermined property specific range, the secondary prime mover is controlled S3 to generate a propulsion torque. Hence, when the property is within the predetermined property specific range it is considered safe to initiate propulsion of the AVC 100 using the secondary prime mover 107.

It is to be understood that the present disclosure is not limited to the embodiments described above and illustrated in the drawings; rather, the skilled person will recognize that many changes and modifications may be made within the scope of the appended claims.

1. A method of controlling operation of an articulated vehicle combination (AVC), the AVC comprising a tractor unit comprising a primary prime mover for propulsion of the AVC, a first trailer unit coupled to the tractor unit by a first articulated coupling, a dolly comprising a secondary prime mover, the dolly being coupled to the first trailer unit by a second articulated coupling, and a second trailer unit coupled to the dolly by a third articulated coupling, the method comprising:
determining at least one property indicative of a stability of the AVC, the at at least one property comprising a coupling force parameter of at least one of the first, second, or third articulated couplings;
comparing the coupling force parameter with a predetermined force parameter range; and
controlling the secondary prime mover to generate a propulsion torque for the AVC when the coupling force parameter is within the predetermined force parameter range.

2. The method of claim 1, further comprising:
reducing an operational capacity of the primary prime mover when controlling propulsion using the secondary prime mover.

3. (canceled)

4. The method a of claim 1, wherein the coupling force parameter comprises a lateral force component exposing the at least one of the first, second, or third articulated couplings to a lateral force during operation of the AVC.

5. The method of claim 1, wherein the coupling force parameter comprises a torque component exposing at least one of the first, second or third articulated couplings to a torque around a longitudinally extending geometric axis during operation of the AVC.

6. The method of claim 1, wherein the at least one property comprises an articulated angle of at least one of first, second or third articulated couplings during operation of the AVC, wherein the secondary prime mover is controlled to generate the propulsion torque when the articulated angle is within a predetermined angle range.

7. The method of claim 1, wherein the at least one property comprises a lateral slip parameter indicative of a lateral slip value of at least one wheel of the AVC, wherein the secondary prime mover is controlled to generate the propulsion torque when the lateral slip value is within a predetermined slip range.

8. The method of claim 1, further comprising:
determining a first longitudinal force parameter value of the AVC during propulsion solely using the primary prime mover; and
controlling the primary and secondary prime movers to contemporaneously generate a propulsion torque exposing the AVC to a second longitudinal force parameter value during a transition period when initiating propulsion using the secondary prime mover, the second longitudinal force parameter value being within a predetermined range from the first longitudinal force parameter value.

9. The method of claim 1, further comprising:
determining a first lateral force parameter value of the AVC during propulsion solely using the primary prime mover; and
controlling the primary and secondary prime movers to contemporaneously generate a propulsion torque exposing the AVC to a second lateral force parameter value during a transition period when initiating propulsion using the secondary prime mover, the second lateral force parameter value being within a predetermined range from the first lateral force parameter value.

10. The method of claim 1, further comprising:
determining a first angle value of at least one of the first, second and third articulated couplings during propulsion solely using the primary prime mover; and
controlling the primary and secondary prime movers to contemporaneously generate a propulsion torque exposing the AVC to a second angle value during a transition period when initiating propulsion using the secondary prime mover, the second angle value being within a predetermined range from the first angle value.

11. The method of claim 1, wherein the primary prime mover is an internal combustion engine of the tractor unit.

12. The method of claim 1, wherein the secondary prime mover is at least one electric machine of the dolly.

13. An articulated vehicle combination (AVC), control system configured to control operation of an AVC comprising a tractor unit comprising a primary prime mover for propulsion of the AVC, a first trailer unit coupled to the tractor unit by a first articulated coupling, a dolly comprising a secondary prime mover, the dolly being coupled to the first trailer unit by a second articulated coupling, a second trailer unit coupled to the dolly by a third articulated coupling, and at least one sensor arranged to sense at least one property indicative of a stability of the AVC, wherein the AVC control system comprises control circuitry configured to:
receive a signal indicative of the property from the at least one sensor, the property comprising a coupling force parameter of at least one of the first, second, or third articulated couplings;
compare the coupling force parameter with a predetermined force parameter range; and
transmit a propulsion signal to the secondary prime mover, the propulsion signal allowing the secondary prime mover to generate a propulsion torque for the AVC when the coupling force parameter is within the predetermined force parameter range.

14. The AVC control system of claim 13, wherein the AVC control system comprises a tractor unit control system and a dolly control system, wherein the tractor unit control system is configured to control operation of the primary prime mover, and the dolly control system is configured to control operation of the secondary prime mover.

15. The AVC control system of claim 14, wherein the control circuitry is configured to transmit the propulsion signal to the dolly control system, the propulsion signal representing instructions which, when executed by the dolly control system, cause the secondary prime mover to generate the propulsion torque.

16. The AVC control system of claim 14, wherein the control circuitry is configured to transmit a propulsion reduction signal to the tractor unit control system, the propulsion reduction signal representing instructions which, when executed by the tractor unit control system, cause the primary prime mover to reduce its operational capacity.

17. An articulated vehicle combination (AVC) comprising a tractor unit comprising a primary prime mover for propulsion of the AVC, a first trailer unit coupled to the tractor unit by a first articulated coupling, a dolly comprising a secondary prime mover, the dolly being coupled to the first trailer unit by a second articulated coupling, a second trailer unit coupled to the dolly by a third articulated coupling, and the AVC control system of claim 13.

18. A computer program comprising program code means for performing the steps of claim 1 when the program is run on a computer.

19. A computer readable medium carrying a computer program comprising program means for performing the steps of claim 1 when the program means is run on a computer.
